(19) United States
(12) Patent Application Publication
(10) Pub. No.: US 2018/0215025 A1
(43) Pub. Date: Aug. 2, 2018

(54) TOOL HANDLE LOCK

(71) Applicant: WORKTOOLS, INC., Chatsworth, CA (US)

(72) Inventor: Joel S. Marks, Sherman Oaks, CA (US)

(73) Assignee: WORKTOOLS, INC., CHATSWORTH, CA (US)

(21) Appl. No.: 15/422,182

(22) Filed: Feb. 1, 2017

(51) Int. Cl. B25C 5/06; F16P 1/00

(52) U.S. Cl. CPC B25C 5/06; F16P 1/00

(57) ABSTRACT

A handle lock for a handle-operated tool, wherein the handle lock includes a stowed position and a deployed position. When biased into the stowed position, the handle lock is integrated and blended to a body of the tool. The deployed handle lock is stable upon forcible motion of the closed handle, the lock preferably requiring a secondary action to release the handle and stow the lock. Optionally, the handle lock can be stowed by forcibly pressing the handle toward the open or closed position. A spring bias holds the lock in the stowed position.

### FIELD OF THE INVENTION

The present invention relates to tool handle locks. More precisely the present invention is directed to improvements to a lock to hold a handle in a storage configuration.

### BACKGROUND OF THE INVENTION

Many tools have an operating handle with a free, cantilevered end. Tool handle locks are used to hold such a movable handle in a closed, folded, or otherwise non-operative position. One such type of lock, for example is a D-ring or similar structure that swivels or moves over a rear of a handle. However, when the handle is unlocked to its operative positions the D-ring will often move into the path of the handle and inhibit operation. Even when the D-ring is intended to have a secure position out of the way of the moving handle, placing it into this position requires an extra operation that is often ignored by the user. Further, the D-ring can accidentally move out of this stowed position. It is also common that the operation of a handle lock is not intuitive, or the handle lock is of such a design that it is not even apparently present to the user. It is important that the lock be sturdy such that it will not break or fail when subject to reasonably contemplated use and abuse.

### SUMMARY OF THE INVENTION

The present invention includes an improved deployable lock to hold a handle in a non-operative position. The lock may be in the form of a clip, hook, arm or other movable feature. Preferably the lock includes stable positions in both the deployed condition and the stowed condition. The exemplary lock is preferably blended to a body of the associated tool when stowed so that is does not visually or functionally compromise the tool when so positioned. The exemplary lock is preferably spring biased toward the stowed position to ensure it remains out of the way when the tool is in use. It is held in the deployed position by a detent, friction or other holding means. In the exemplary embodiment, a resilient detent arm selectively holds the lock in the deployed position against the spring bias. The resilient arm is separately movable so that by directly deflecting the resilient arm the lock will move or gently snap into its stowed position preferably under the spring bias. Optionally, the lock may be released from deployment by forcing the handle against the lock to cause the lock to rotate or move and to then cause the detent arm to disengage from the body.

### BRIEF DESCRIPTION OF THE DRAWINGS

FIG. 1 is a left side elevational view of a tool incorporating a preferred embodiment deployable handle lock, with the lock in the deployed position.

FIG. 2 is an upper perspective view of the tool of FIG. 1 with the lock stowed.

FIG. 3 is a detail view of a rear end of the opposite side of the tool of FIG. 2, showing a tool interior with the lock stowed, the handle being in a lengthwise cross-sectional view

FIG. 4 shows the lock of FIG. 3 with the lock deployed to hold a handle in a closed position.

FIG. 5 shows the lock of FIG. 4 with the lock partly moved toward the stowed position and the handle partly raised.

FIG. 5A is a detail view of the lock from FIG. 5 showing an arm detent action.

FIG. 6 is a rear right perspective view of the stowed lock tool of FIG. 3.

FIG. 7 is a rear right perspective view of the deployed lock tool of FIG. 4.

FIG. 8 is a rear right perspective view of the partly deployed lock tool of FIG. 5.

FIG. 9 is a bottom perspective view of the handle.

FIG. 10 is a rear perspective view of the handle lock structure.

FIG. 11 is a detailed cross-sectional view of the end portion of the handle of FIG. 9.

### DETAILED DESCRIPTION OF THE PREFERRED EMBODIMENTS

The present invention is directed to a handle lock for any tool that has some form of operating handle. The drawing figures depict such a tool, which is this exemplary embodiment, is a staple gun. Other such devices are contemplated, but not limited to, pruning shears, pliers, power tools, garden tools, garden hose nozzle, paint spray guns, kitchen accessories, etc., may include movable operating handles that can beneficially include the features of the present invention.

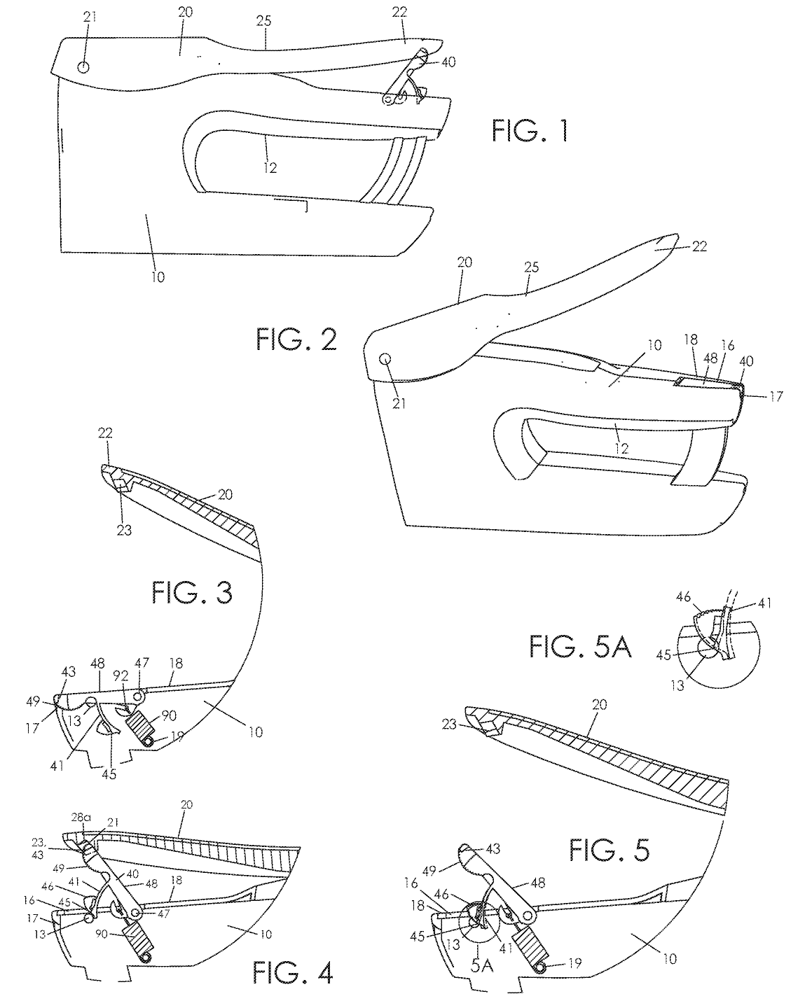

In an exemplary embodiment, a staple gun type of device or tool is shown (FIG. 1), which tool includes handle 20 that can open, swing, move, or pivot to extend away from body 10. The handle 20 is depressed, deflected or otherwise moved to actuate working elements of the tool. In the staple gun, the handle 20 operates to energize a power spring or energy storage spring (not shown). This spring causes a normal rest position with the handle in the extended position of FIG. 2. A re-set or restoring spring (not shown) also typically operates to bias the handle 20 toward the extended position at the end of an operating cycle. With the handle 20 extended, the tool requires more space to store than if the handle were held in the closed position of FIG. 1. Therefore, it is desirable to store the tool with the handle closed as in FIG. 1. In addition, with the handle held closed, the tool is less likely to be accidentally operated or cycled, whereby the tool can be more safely and compactly stored. Since the handle is biased to remain open, a locking structure is normally required to selectively hold the handle closed.

To be practical, a tool handle lock should be simple and convenient enough to use that a user will, under normal circumstances, actually use it when it is beneficial to do so. Further, when it is not in use, the lock should not visually or physically add to the bulk or complexity of the associated device. According to features of the present invention, a handle lock is fully stowable and easily operated.

In FIGS. 1 and 2, an exemplary staple gun is shown in simplified, side elevational views. In FIG. 1, handle lock 40 is deployed to span between tool body 10 and operating handle 20 to hold handle 20 in its closed position. The closed position may be considered that which has the handle moved near or to a position that has a minimal grip size for the tool. In FIG. 2, handle lock 40 is stowed and handle 20 has pivoted about hinge 21 to its open or rest position. In FIGS. 1 and 2, the grip is generally defined as the distance between upper grip area 25 of the handle 20 and lower grip area 12 on body 10. Accordingly, the grip size is less in FIG. 1 than it is in FIG. 2. Other tool configurations or types may have the closed position being other than a minimal grip size, for example, with a handle rotated away from the body.

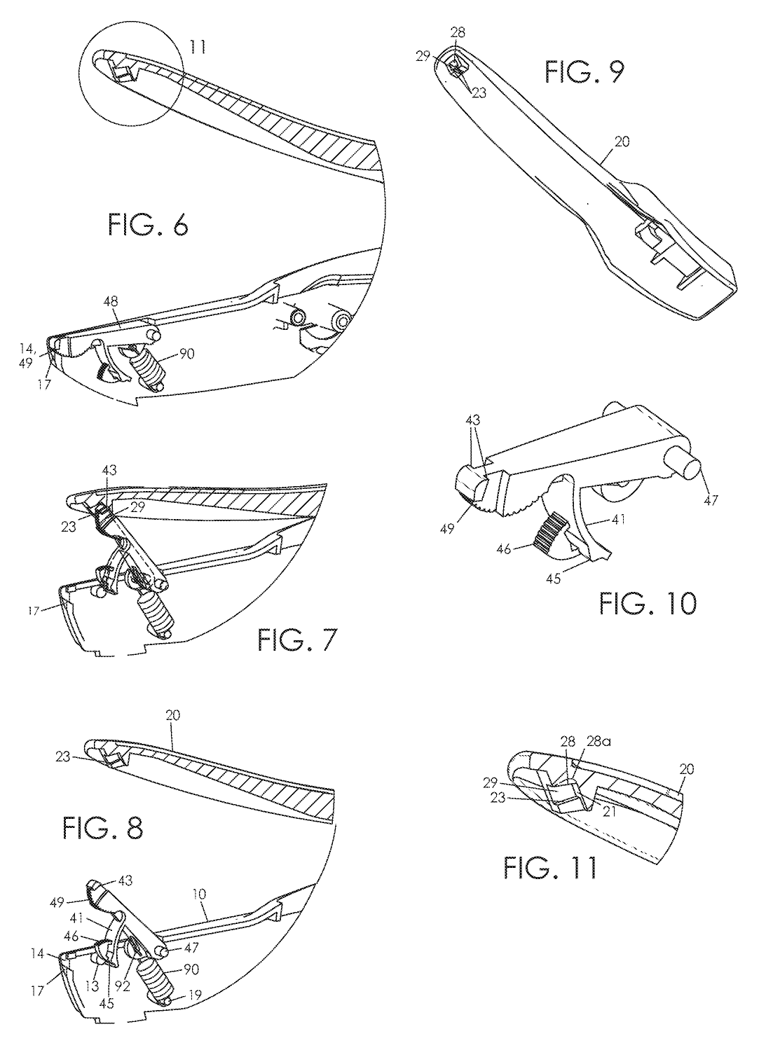

In FIGS. 2 and 3, handle 20 is spaced away from body 10. FIGS. 3 to 8 show detail views of an exemplary embodiment of the invention. In FIGS. 3-5, handle lock 40 has preferably a strut shape with an arcuate arm 41 branching out from the strut, and is pivoted about hinge 47 so that upper lock face 48 is preferably fitted in recess 16 and is flush, blended, or integrated to upper face 18 of body 10. To deploy the handle lock 40, a user manually pushes the handle lock from below at face 49 at the distal end of the strut from within recess 17. With the preferred provision of recess 17 in body 10, the handle lock can include a rearward and downwardly exposed portion of face 49 while lock 40 does not significantly protrude from an envelope or profile of body 10. In this manner, lock 40 is readily deployed manually, i.e., by finger pressure of the user, while remaining blended to a surrounding body structure. While the shape is preferably blended, the handle lock may be visually called out by using different molded colors, paint, and/or textures to ensure the user knows the locking feature is available.

To prepare the tool handle 20 to be in the closed position of FIG. 4, the handle should be lightly biased to open from this position. In the case of the exemplary staple gun, the power spring within the staple gun will cause a large opening bias upon the handle until the power spring is cycled to de-link from the handle. This is very common to most staple gun operation. The handle 20 is therefore normally partially cycled before storage with handle 20 stopped with the power spring de-linked and before being re-set to the open position. As a result, the full force of the power spring is preferably not biasing the handle toward its open position. Such bias is then limited to the force of a re-set spring acting on the handle. Nevertheless, handle lock 40 is preferably strong enough that it can hold the tool handle 20 closed even against the bias of a power spring or other high opening forces, when present.

The preferred embodiment handle lock 40 includes resilient arm 41 with detent 45. When the lock 40 is moved toward the deployed position of FIG. 4, arm 41 flexes as detent 45 is forced over post 13 of body 10. This position is seen in FIG. 5A. Arm 41 is shown deflected in dashed lines with detent 45 pressing post 13. In the fully deployed position of FIG. 4, detent 45 has moved past post 13 and lock 40 will remain in this position against the bias force of return spring 90.

While lock 40 is deployed, handle 20 is held in or near its closed position. In FIG. 7, this position has ribs 43 or equivalent structure moved to be engaged to shelf 23 of the handle. For clarity, handle 20 is shown in cross-section in most views. In FIG. 9, the full shelf structure 23 of the exemplary embodiment is shown including a slot between the two opposed shelves to fit an extension of lock 40 which supports ribs 43. Lock 40 is held generally stable in the deployed position by detent 45. To deploy the lock, interface 49 is pressed upward. Interface 49 preferably includes an arcuate profile or shape so that a user's finger can roll upon its surface as lock 40 pivots upward. In this manner, the finger can start from a rear of face 49 at body recess 17 while the finger can roll downward along face 49 so that when near the position of FIG. 4, the finger is clear of the under structure of handle 20. Interface 49 may be serrated as shown in the exemplary views to help maintain finger contact and grip. Once deployed, lock 40 has a sturdy connection to handle 20. Handle 20 preferably is near but not fully at its lowest possible position in FIG. 4 so that there is some clearance for a short closing handle motion during a releasing action to disengage the handle from the lock 40.

To stow handle lock 40, button 46 may be pressed. This action deflects arm 41 away from post 13 and also urges detent 45 to move down. Lock 40 can then pivot out from shelf 23. Preferably shelf 23 is angled away from hinge 47 relative to the downward pivoting of lock 40, specifically being farther from hinge 47 as the lock pivots toward the stowed position. This shelf angle can be seen in FIG. 4. Handle 20 then moves slightly downward as the lock disengages shelf 23. This cam action ensures that forcible pulling on the handle will not disengage the lock, but rather bias the lock further forward onto shelf 23 up to a stop rib as shown. Other angles or no angle may be used, for example, shelf 23 may be concentric to pivot 47. Friction between shelf 23 and ribs 43 along with detent 45 may then hold the lock deployed. With a sufficient opposed shelf angle, simple forcible pulling on handle 20 toward the open position may overcome detent 45 and release the lock. As lock 40 continues to rotate, ribs 43 are no longer engaged. Handle 20 is free to move to its open position while lock 40 moves to its stable stowed position.

Ribs 43 normally press lightly against shelf 23 under the bias of the handle re-set spring. There is preferably some clearance for free motion handle 20 at slot 29 about ribs 43 as handle 20 pivots slightly. See slot 29 in FIG. 11. According to the secondary holding action of detent 45, lock 40 stays deployed if handle 20 is slightly pressed or bumped against the bias of the re-set spring to cause ribs 43 to lose contact with shelf 23. Lock 40 stays in the deployed position and disengages from this position only when specifically intended.

As seen in FIGS. 4 and 11, shelf 23 faces ceiling 28 in slot 29. Ceiling 28 is optionally angled rearward as shown relative to hinge 47. With this geometry, it is possible that lock 40 can be moved to disengage the handle by forcing the handle downward. As ribs 43 contact ceiling 28, the cam angle causes the lock to rotate counterclockwise in the view of FIG. 4. With motion induced by the handle, then detent 45 can be moved past post 13 without a user pressing button 46. This structure allows the handle to be manually released by a single hand.

Ceiling 28a is an alternative profile for ceiling 28. Ceiling 28a angles forward whereby when handle 20 is pressed downward, lock 40 presses the ceiling and the lock is urged forward toward wall 21. Wall 21 limits further motion of lock 40. With ceiling 28a or other structure to prevent downward handle motion from causing de-latching of lock 40, the handle will remain stowed. It will be released only upon release of the secondary holding action, this being pressing button 46 in the exemplary embodiment. With the need for a secondary action, the handle remains stable against most actions to the handle when it is closed. With or without the need for a secondary action, the lock will snap to its stowed position once detent 45 has moved past post 13, or equivalent structure, under the bias of spring 90.

While the particular forms of the invention are illustrated and described above, it will be apparent that various modifications can be made without departing from the spirit and scope of the invention. It is contemplated that elements from one embodiment may be combined or substituted with elements from another embodiment. For example, the exemplary handle lock is shown as a feature of a staple gun. Its equivalent features may be incorporated with other tools or implements. In the above description, the references to forward, rearward, up or down are used only as conventions for describing the structure and should not be construed as any limitation on the present invention.

What is claimed is:

1. A tool including a movable handle thereon, comprising:
a body, the handle pivotally attached to the body including an open position and a closed position of the handle on the body;
a handle lock pivotally attached to the body including a deployed position and a stowed lock position;
a biasing element to bias the handle lock toward the stowed position; and
a detent member attached to the handle lock to releasably engage the body to hold the handle lock in the deployed position against a force of the biasing element, wherein upon release of the detent member, the biasing element moves the handle lock to the stowed position.

2. The tool of claim 1, wherein the deployed position of the lock includes the lock engaged to the handle to hold the handle in the closed position.

3. The tool of claim 2, wherein the handle is pivoted to the body at a handle first end, and the lock engages the handle at a handle second end.

4. The tool of claim 1, wherein the stowed position of the handle lock includes the handle lock being in a recess of the body and flush with a face of the body.

5. The tool of claim 2, wherein the handle lock is fitted to a top, rear of the body, below a rear distal end of the handle, and the deployed position includes the handle lock spanning between the rear of the body and the rear end of the handle.

6. The tool of claim 2, wherein a rib of the handle lock engages a shelf of the handle.

7. The tool of claim, 1 wherein a rear end of the handle lock is exposed at a rear of the body, and the rear of the handle lock is operable by a finger to raise the handle lock to its deployed position.

8. The tool of claim 6, wherein a ceiling of the handle is near the shelf, and the ceiling is angled in relation to the handle lock, wherein pressing the handle toward the body causes the handle lock to rotate and release the detent member.

9. The tool of claim 1, wherein the detent member is attached to a flexible arm of the handle lock wherein the detent member is resiliently movable on the handle lock.

10. The tool of claim 9, wherein the detent member engages the body at a post of the body.

11. A tool including a movable handle, comprising:
a body, wherein the handle is pivotally attached to the body and includes an open position and a closed position of the handle relative to the body;
a handle lock pivotally attached to the body including a deployed position and a stowed lock position, the deployed position including the handle held by the handle lock in the closed position; and
wherein the handle lock, in the stowed position, is fitted within a recess of the body and flush with adjacent faces of the body to be blended to a surrounding body structure.

12. The tool of claim 11, wherein a rear end of the handle lock is exposed at a rear of the body, and the rear of the handle lock is manually operable to raise the handle lock to its deployed position.

13. The tool of claim 11, wherein a biasing element biases the handle lock toward the stowed position to retain the handle lock stable in the stowed position.

14. The tool of claim 13, wherein a detent member is attached to the handle lock to releasably engage the body to hold the handle lock in the deployed position against a force of the biasing element, wherein upon release of the detent member the biasing element moves the handle lock to the stowed position.

15. The tool of claim 14, wherein the detent member is attached to a flexible arm of the handle lock, wherein the detent member is resiliently movable on the handle lock.

16. The tool of claim 11, wherein the deployed position includes a rib of the handle lock extending within a slot of the handle.

17. The tool of claim 11, wherein the handle lock includes a strut shape and is pivoted to the body at one end and engageable with the handle at an opposite end, and wherein the strut shape includes an arcuate shape arm branching therefrom.
